(19) United States
(12) Patent Application Publication
(10) Pub. No.: US 2016/0198296 A1
(43) Pub. Date: Jul. 7, 2016

(54) APPARATUS FOR CONTROLLING USER DEVICE, METHOD OF DRIVING THE SAME, AND COMPUTER READABLE RECORDING MEDIUM

(71) Applicant: Samsung Electronics Co., Ltd., Gyeonggi-do (KR)

(72) Inventors: Young-bin JUNG, Gyeonggi-do (KR); Jung-hyun SHIM, Gyeonggi-do (KR); Seung-hwan CHOI, Gyeonggi-do (KR)

(73) Assignee: Samsung Electronics Co., Ltd.

(21) Appl. No.: 14/990,343

(22) Filed: Jan. 7, 2016

(30) Foreign Application Priority Data
Jan. 7, 2015 (KR) 10-2015-0001909

(51) Int. Cl. H04W 4/02; H04W 8/18

(52) U.S. Cl. CPC H04W 4/021; H04W 8/183

(57) ABSTRACT

An apparatus for controlling a user device, a method of controlling an apparatus for controlling the user device, and a non-transitory computer readable recording medium are provided. The user device control apparatus includes a storage for storing state information relating to a state of a first space, a controller, if a user enters the first space, searching for the stored state information relating to the state of the first space and a communication interface for transmitting the searched state information to a user apparatus of the first space to control the user apparatus based on the searched state information.

### PRIORITY

This application claims priority under 35 U.S.C. §119(a) to Korean Patent Application No. 10-2015-0001909, which was filed on Jan. 7, 2015, the entire content of which is incorporated herein by reference.

### BACKGROUND

1. Field of the Disclosure

The present disclosure generally relates to an apparatus for controlling a user device, a method of controlling the user device, and a computer readable recording medium, and more particularly, to an apparatus for controlling a user device that is capable of providing a smart service supporting user customized device control based on, for example, a space subdivision, a method of controlling the user device, and a computer readable recording medium.

2. Description of the Related Art

Conventional location based services are limited to estimation of a location within a recognition range. Conventional location based services have been provided relative to a service divided between indoors and outdoors and controlling devices near a specific location. A method of setting a geographically specific region through GPS, sensing whether a user enters the specific region, and recognizing a location through the sensing, which is called geo-fencing, and a method of recognizing a user device by a sensor near an exit space, transmitting the recognition to a gateway, and determining a user device presence and absence have been well known.

However, for a location based services, it is inconvenient for a user to personally divide and register space. An existing indoor location based service also has difficulty in considering a plurality of users and providing a customized service with respect to a private space. Furthermore, there are problems in that it is difficult to provide a service interworking a plurality of apparatuses in a specific space, and in the case where similar devices don't exist, it is difficult to provide a continuous service to the user.

### SUMMARY

The present disclosure has been made to at least address the above and other disadvantages and to provide at least the advantages described below.

According to an aspect of the present disclosure, an apparatus for controlling a user device that is capable of providing a smart service supporting a user customized device control based on space subdivision, a method of driving the apparatus for controlling the user device, and a computer readable recording medium are provided.

According to an aspect of the present disclosure, a user device control apparatus includes a storage for storing state information relating to a state of a first space, a controller, if a user enters the first space, searching for the stored state information relating to the state of the first space, and a communication interface for transmitting the searched state information to a user apparatus of the first space to control the user apparatus based on the searched state information.

According to another aspect of the present disclosure, a method of driving a user device control apparatus includes storing state information relating to a state of a first space; if a user enters the first space, searching for the stored state information relating to the state of the first space; and transmitting the searched state information to a user apparatus of the first space to control

According to another aspect of the present disclosure, a non-transitory computer readable recording medium having recorded thereon a computer program which performs a user device control method is provided, the user device control method including storing state information relating to a state of a first space, if a user enters the first space, searching for the stored state information relating to the state of the first space and transmitting the searched state information to a user apparatus of the first space to control the user apparatus based on the searched state information.

### BRIEF DESCRIPTION OF THE DRAWING FIGURES

The above and other aspects, features and advantages of the present disclosure will be more apparent from the following detailed description taken in conjunction with the accompanying drawings, in which:

FIG. 1 is a block diagram of a user device control system, according to an embodiment of the present disclosure;

FIG. 2A is a diagram describing an operation of user apparatuses when a user enters an arbitrary space;

FIG. 2B is a diagram describing an operation of user apparatuses when a user moves from another space to an arbitrary space;

FIGS. 3 and 4 are diagrams for describing an operation of a user device control apparatus of FIG. 1;

FIG. 5 is a block diagram of a structure of the user device control apparatus of FIG. 1;

FIG. 6 is a diagram of a control method of FIG. 5;

FIGS. 7 and 8 are diagrams for describing a state reproduction of a space state reproducer of FIG. 6;

FIGS. 9A and 9B are diagrams for describing an information input process through interaction with a user;

FIG. 10 is a block diagram of another structure of the user device control apparatus of FIG. 1;

FIG. 11 is a flowchart of a process of controlling a user device control apparatus, according to an embodiment of the present disclosure;

FIG. 12 is a flowchart of a process of reproducing a state based on a state value for each device;

FIG. 13 is a flowchart of a process of reproducing a state based on an environment state value for each space;

FIG. 14 is a flowchart of a process of automatically grouping devices for each space;

FIGS. 15A and 15B are screen shots for describing a process of acknowledging and correcting a reproduction state;

FIGS. 16A through 16D are diagrams for describing a regrouping process when there is an error in automatic grouping;

FIG. 17 is a block diagram of a modification of a system of FIG. 1;

FIG. 18 is a block diagram of another modification of a system of FIG. 1;

FIG. 19 is a block diagram of a user device control system according to another embodiment of the present disclosure;

FIG. 20 is a flowchart of a device grouping process for each space using the system of FIG. 19;

FIG. 21 is a flowchart of a process of setting a representative device for each space using the system of FIG. 19;

FIG. 22 is a flowchart of a process of simultaneously storing states of devices in an arbitrary space using the system of FIG. 19;

FIG. 23 is a block diagram of a user device control system for simultaneously reproducing device states;

FIG. 24 is a flowchart of a process of simultaneously reproducing device states using the system of FIG. 23;

FIGS. 25 through 27 are diagrams of inputting a user command for storing state information of a user apparatus and reproducing a state of the user apparatus;

FIG. 28 is a block diagram of a user device control system for a customized service for each user;

FIG. 29 is a flowchart of a service process using the system of FIG. 28; and

FIG. 30 is a diagram of a user device control system according to another embodiment of the present disclosure.

### DETAILED DESCRIPTION

The embodiments of the present disclosure may be modified. Accordingly, specific embodiments are illustrated in the drawings and are described in detail in the following detailed description. However, it is understood that the present disclosure is not limited to a specific embodiment, but includes all modifications, equivalents and substitutions without departing from the scope and spirit of the present disclosure. Also, well-known functions or constructions are not described in detail since they would obscure the disclosure with unnecessary detail.

The terms “first”, “second”, etc. may be used to describe diverse components, but the components are not limited by the terms. The terms are only used to distinguish one component from the others.

The terms used in the present application are only used to describe the embodiments, and are not intended to limit the scope of the disclosure. Singular expressions also include the plural meanings as long as it does not specifically mean plural in the context. In the present application, the terms “include” and “consist of” designate the presence of features, numbers, steps, operations, components, elements, or a combination thereof that are written in the specification, but do not exclude the presence or possibility or addition of one or more other features, numbers, steps, operations, components, elements, or a combination thereof.

In an embodiment of the present disclosure, a “module” or a “unit” performs at least one function or operation, and may be implemented with hardware, software, or a combination of hardware and software. In addition, a plurality of “modules” or a plurality of “units” may be integrated into at least one module except for a “module” or a “unit” which has to be implemented with specific hardware, and may be implemented with at least one processor.

Embodiments of the present disclosure will now be described in greater detail with reference to the accompanying drawings.

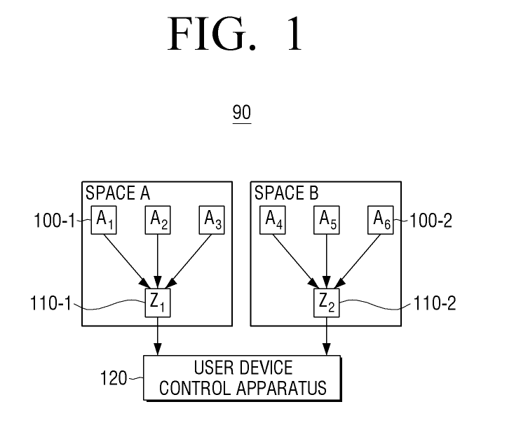

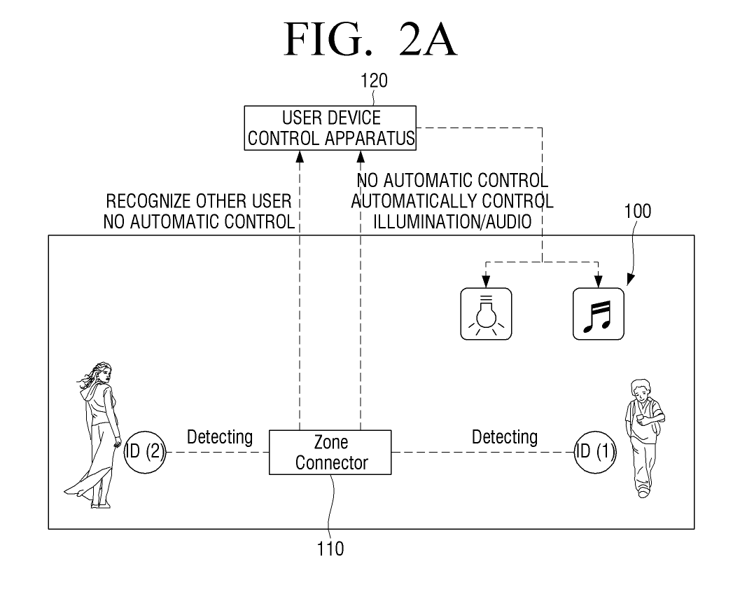

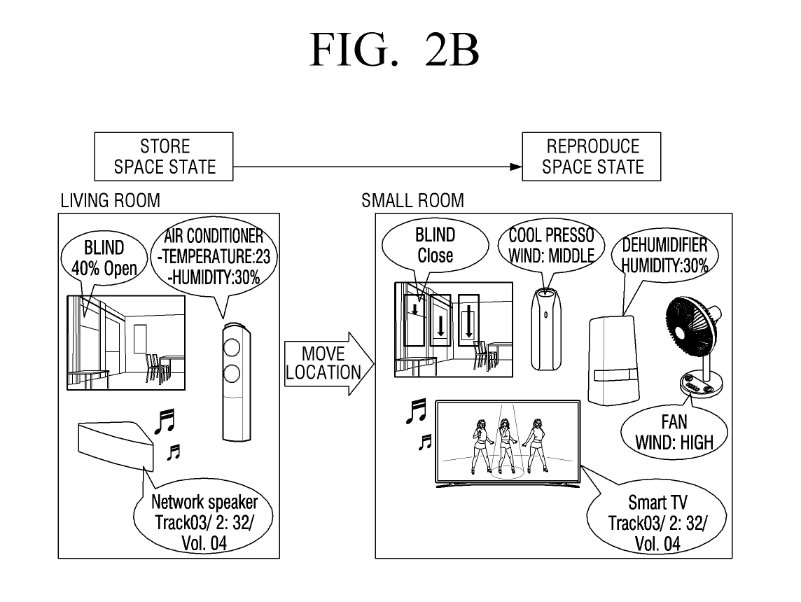

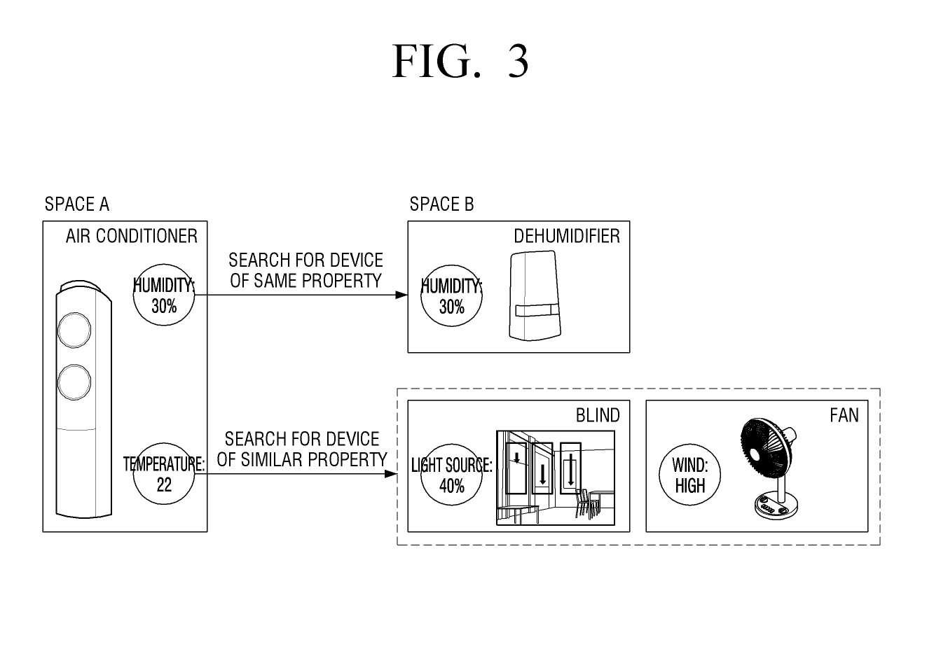

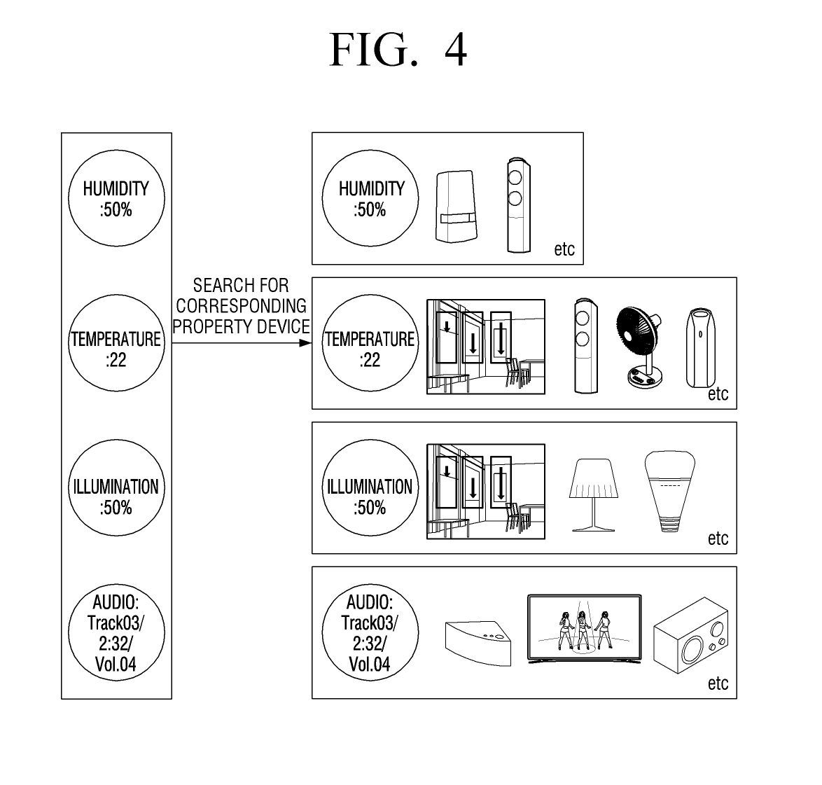

FIG. 1 is a block diagram of a user device control system 90, according to an embodiment of the present disclosure. FIG. 2A is a diagram for describing an operation of user apparatuses when a user enters an arbitrary space. FIG. 2B is a diagram for describing an operation of user apparatuses when a user moves from another space to an arbitrary space. FIGS. 3 and 4 are diagrams for describing an operation of a user device control apparatus 120 of FIG. 1.

As shown in FIG. 1, the user device control system 90 according to an embodiment of the present disclosure includes a part or a whole of user apparatuses 100-1 and 100-2, zone connectors 110-1 and 110-2, and the user device control apparatus 120.

Including the part or the whole means that the user device control system 90 may be configured by omitting the user apparatus 100-2 and the zone connector 110-2 of a space B, etc. For sufficient understanding of the present disclosure, the user device control system 90 will be described by including the whole system.

The user apparatuses 100-1 and 100-2 include electronic devices provided in arbitrary spaces (space A and space B). For example, the user apparatuses 100-1 and 100-2 may include various apparatuses such as a TV, a refrigerator, an air conditioner, an audio device, a fan, a window blind apparatus, an illumination apparatus, a dehumidifier, a small cooling device, a plurality of sensors, etc. as electronic devices. In this regard, a sensor may be an illumination sensor, a humidity sensor, etc. The user apparatuses 100-1 and 100-2 are controlled by being connected to the zone connectors 110-1 and 110-2 that manage communication of each space to provide operation state information thereof to the zone connectors 110-1 and 110-2.

If the zone connectors 110-1 and 110-2 are installed in each space, the user apparatuses 100-1 and 100-2 communicate with the zone connectors 110-1 and 110-2 installed in the same space as the user apparatuses 100-1 and 100-2 to provide apparatus IDs thereof. The provided apparatuses IDs may be stored by being transferred to the user device control apparatus 120 through the zone connectors 110-1 and 110-2, and thus each space may be divided.

If a room occupant leaves his/her space and the corresponding space after a certain period of time without re-entry of the room occupant, the user apparatuses 100-1 and 100-2 of each space may transfer a current operation state and an environment state to the zone connectors 110-1 and 110-2 to store the current operation state and the environment state in the user device control apparatus 120. The environment state may refer to illumination of the space or humidity, etc. but may also be an operation state of a sensor. If a user enters his/her space again, the zone connectors 110-1 and 110-2 may detect re-entry of the user, notify the user device control apparatus 120 of the detection, retrieve information regarding the current operation state and the environment state stored in the user device control apparatus 120 and transfer the information to the user apparatuses 100-1 and 100-2. The user apparatuses 100-1 and 100-2 may operate based on the received information.

Referring to FIG. 2A, a room occupant, i.e. a representative user in an arbitrary space may be set. In this regard, setting may be stored in the form of an apparatus ID of a mobile terminal apparatus such as a portable phone of the user. In other words, if a phone number or other user identifier is input so as to designate the user to be the representative user of the corresponding space through the mobile terminal apparatus, the apparatus ID of the mobile terminal apparatus may be transmitted to and stored in the user device control apparatus 120 based on the input phone number or other user identifier. Thus, when there is entry of the user designated as the representative user, the user apparatuses 100-1 and 100-2 may be automatically controlled, whereas, when there is entry of a non-registered user who is not the representative user, the user apparatuses 100-1 and 100-2 may not be automatically controlled.

As shown in FIG. 2B, when the user moves from the space A that is the same as a living room to the space B that is a room of the user, the user apparatuses 100-2 of the space B may reproduce a state of the space A. In this regard, reproduction may refer to whether the user apparatuses 100-2 of the space B operate to achieve substantially the same state as that of the user apparatuses 100-1 of the space A, in which the user apparatus 100-2 of the space B operates at the same value when the same device or the user apparatus 100-1 of the same property exists in the space A, whereas when the user apparatus 100-2 of the same property does not exist, the user apparatus 100-2 of a similar property operates. For example, in FIG. 2B, since an operation of the air conditioner of the space A replaces the small cooling device, the dehumidifier and the fan of the space B, although the space A and space B are not substantially in the same state, the space A and space B may be in a similar state.

The user apparatuses 100-1 and 100-2 of each space may be controlled according to the information transmitted from the zone connectors 110-1 and 110-2 of each space through the user device control apparatus 120, and thus the user apparatuses 100-1 and 100-2 of each space may be controlled apparatuses of the user device control apparatus 120.

The zone connectors 110-1 and 110-2 of each space may respectively manage operation control of the user apparatuses 100-1 and 100-2 that are present in the same space, whereby if previously stored state information is provided, the user device control apparatus 120 provides the previously stored state information to each of the user apparatuses 100-1 and 100-2. During this process, the zone connectors 110-1 and 110-2 may parse and provide received information to each of the user apparatuses 100-1 and 100-2. In other words, the zone connectors 110-1 and 110-2 of each space communicate with each of the user apparatuses 100-1 and 100-2 before transferring the parsed information, obtain apparatus IDs, compare the apparatus IDs with apparatus IDs of the parsed information, and transfer the parsed information to the user apparatuses 100-1 and 100-2 that are identical to the apparatus IDs of the parsed information. Such an operation may be modified. In other words, the zone connectors 110-1 and 110-2 may transmit the received information to all the user apparatuses 100-1 and 100-2 of each space in the same form, and each of the user apparatuses 100-1 and 100-2 may parse information corresponding to each of the user apparatuses 100-1 and 100-2 among the received information and operate based on the parsed information of each of the user apparatuses 100-1 and 100-2. Such an information processing process may vary, and thus the embodiment of the present disclosure is not particularly limited thereto.

The zone connectors 110-1 and 110-2 of each space according to the embodiment of the present disclosure may be a gateway. However, installing a typical gateway in each space may incur great expense. Thus, the zone connectors 110-1 and 110-2 may be apparatuses that have a relatively small communication range and are inexpensive compared to existing gateways. For example, if bi-directional communication is required, a Bluetooth module may be cheaper than a Wi-Fi module, and an infrared (IR) module may be cheaper than the Bluetooth module. Therefore, the zone connectors 110-1 and 110-2 may have any form as long as the zone connectors 110-1 and 110-2 perform only the basic communication operations required in an embodiment of the present disclosure.

The zone connectors 110-1 and 110-2 may detect the user who enters spaces of the zone connectors 110-1 and 110-2 and provide user information of the detected user to the user device control apparatus 120. In this regard, the user information may be the apparatus ID of the mobile terminal apparatus of the user designated as the representative user of the corresponding space. The zone connectors 110-1 and 110-2 may receive state information provided based on the provided apparatus ID and transfer the state information to the user apparatuses 100-1 and 100-2. In this regard, the state information may be different according to entry from an external space to the corresponding space or movement from adjacent internal spaces. Such a determination operation may be performed by the user device control apparatus 120 based on the apparatus ID of the mobile terminal apparatus of the representative user. For example, it may be simply known by comparison if the same apparatus ID is searched in the space A before movement and the space B after movement.

The user device control apparatus 120 may be a home server installed in each home but may also be a cloud server. Although the cloud server is slightly different from the home server in that the cloud server uses a communication network of a communication company, the embodiment of the present disclosure is not particularly limited to a specific server. Other embodiments will be described later.

The user device control apparatus 120 may classify and store state information of the user apparatuses 100-1 provided by the zone connector 110-1 of the space A and state information of the user apparatuses 100-2 provided by the zone connector 110-2 of the space B. For example, if there is a request to store the state information of the user apparatuses 100-1 from the zone connector 110-1 of the space A, the user device control apparatus 120 may store the received state information. If there is a request for the state information from the zone connector 110-1 of the space A, the user device control apparatus 120 may search for the state information based on an apparatus ID of the zone connector 110-1, medium access control (MAC) address information, or other address information, etc. and provide the searched state information. In this regard, the zone connector 110-1 of the space A makes a request after a certain period of time after the user leaves the corresponding space. The user device control apparatus 120 may be capable of determining whether a time period elapses after the user leaves the corresponding space, and thus the embodiment of the present disclosure is not limited thereto.

When the user device control apparatus 120 provides the state information according to the state information search request from the zone connectors 110-1 and 110-2, the user device control apparatus 120 may determine whether to provide the state information according to entry of a new user or according to movement of a user to adjacent spaces. For example, taking into consideration a user location movement from the living room to the small room as shown in FIG. 2B, since a living room space is a common space of family members, a plurality of users may be registered as representative users. If a user registered in the living room space moves to a private space of the user, the user device control apparatus 120 may reproduce the state information of the living room space in the private space of the user. However, in a case where the user is not registered in the living room space, since the case corresponds to new entry of the private space of the user, the user device control apparatus 120 may allow the state information when the user leaves the corresponding space to be reproduced. As such, the user device control apparatus 120 may determine how to reproduce a space state based on representative user information of the space before user movement.

When the user device control apparatus 120 searches for and provides the state information, the user device control apparatus 120 may filter and provide the state information of only the user apparatuses 100-1 of the space A in the corresponding entry or movement space. For example, if the air conditioner is present in both spaces, the user device control apparatus 120 may provide the same state information. During this process, in a case where the user apparatuses 100-1 and 100-2 of the same property are not present, the user device control apparatus 120 may determine the user apparatuses 100-1 and 100-2 of a similar property, combine operation of such replacement devices, and allow a similar state to be reproduced.

More specifically, referring to FIG. 3, the user device control apparatus 120 may know that the environment state according to the air conditioner of the space A is set as humidity of 30% and temperature of 22 degrees. However, if the representative user moves to the space B, the user device control apparatus 120 may determine if there is a device that is the same as the air conditioner or has the same or similar property to that of the air conditioner. As a result of this determination, if the dehumidifier of the same property and the window blind apparatus and the fan that are capable of adjusting temperature are searched, the user device control apparatus 120 may adjust the dehumidifier to maintain the same humidity as that of the space A and the window blind apparatus and the fan to maintain a temperature of 22 degrees C. For example, the user device control apparatus 120 may control the window blind apparatus to open about 40% and control the fan to be set as on high speed as decided by an experiment or a user experience. Information, i.e., values, regarding the experiment or the user experience relating to such a specific control may be retrieved from storage in an internal memory.

When the user enters or moves to an arbitrary space, the user device control apparatus 120 may search for the user apparatuses 100-1 and 100-2 that are capable of reproducing the corresponding state. For example, as shown in FIG. 4, the user device control apparatus 120 may search for a hygrometer or the air conditioner, etc. in order to reproduce a humidity state. In case of temperature, the user device control apparatus 120 may search for the window blind apparatus, the air conditioner, the fan, and the small cooling device, etc. In case of illumination, the user device control apparatus 120 may search for the window blind apparatus, lighting, the illumination apparatus, etc. In case of audio, the user device control apparatus 120 may search for a related apparatus for reproducing audio.

Summarizing information related to similar property devices, the information may be shown in Table 1 and Table 2 below. The user device control apparatus 120 may store the information of the related similar property devices like Table 1 and Table 2 in storage such as a database in the form of a lookup table and determine the similar property devices based on the information.

TABLE 1

| Category | Similar Property Devices | Property |
|---|---|---|
| Illumination | Smart LED light bulb | Illumination + RGB |
| device | Legacy light bulb | Illumination |
| | Automatic blind + illumination | Light source |
| | sensor | |
| Cooling | Air conditioner | Temperature + |
| device | | humidity |
| | Cooler + temperature sensor | Wind |
| | Portable air conditioner + | Wind |
| | temperature sensor | |
| | Fan + temperature sensor | Wind |
| | Ceiling fan + temperature sensor | Wind |
| | Window blind + temperature sensor | Temperature |
| | Humidifier/dehumidifier | Humidity |
| Individual | Radiator + temperature sensor | Temperature |
| Heating | Heater + temperature sensor | Temperature |
| device | Fan heater + temperature sensor | Temperature |

TABLE 2

| | Similar | | |
|---|---|---|---|
| Category | Property Devices | | Property |
| Media | Display | TV | Live channel, title of VOD that is being |
| device | device | | reproduced, reproduction location, |
| | | | volume, etc. |
| | | PC | Titles of local content/VOD that are |
| | | | being reproduced, reproduction |
| | | | location, volume, etc. |
| | | Tablet | Titles of local content/VOD that are |
| | | | being reproduced, reproduction |
| | | | location, volume, etc. |
| | Sound | Radio | Radio frequency, title of music content |
| | device | | that is being reproduced, reproduction |
| | | | location, volume, etc. |
| | | Wireless | Title of music content that is being |
| | | radio | reproduced, reproduction location, |
| | | | volume, etc. |
| | | Audio | Title of music content that is being |
| | | | reproduced, reproduction location, |
| | | | volume, etc. |

If the similar property devices are selected, the user device control apparatus 120 may also use pre-stored information in connection with how to reproduce a desired state by using the corresponding similar property devices. For example, in a case where the window blind apparatus and the fan are searched as the similar property devices in order to reproduce a temperature of 22 degrees C. according to the air conditioner, an example is to adjust a light source of the window blind apparatus to 40% and control the fan to be set in high speed by using the pre-stored information. However, such information may be calculated in real time, and thus the embodiment of the present disclosure may not be particularly limited thereto.

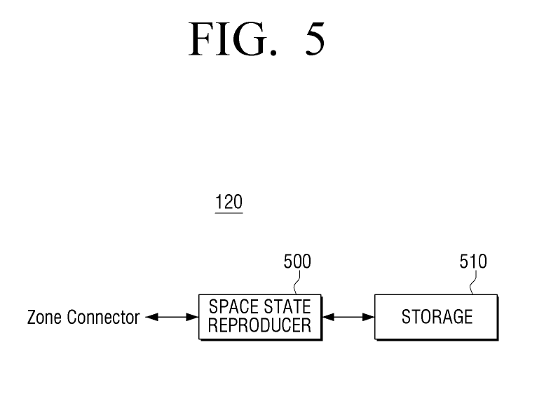

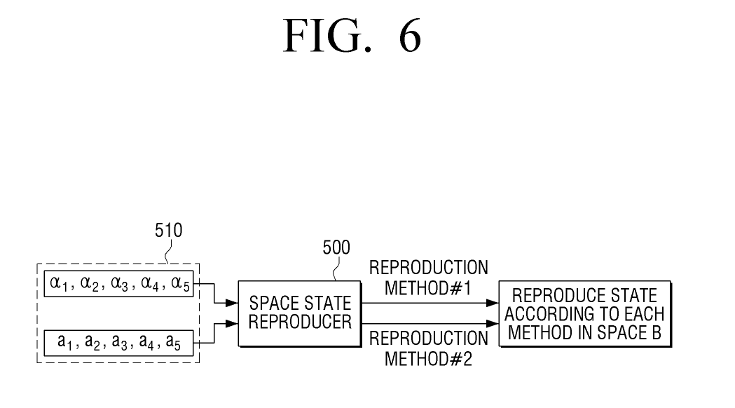

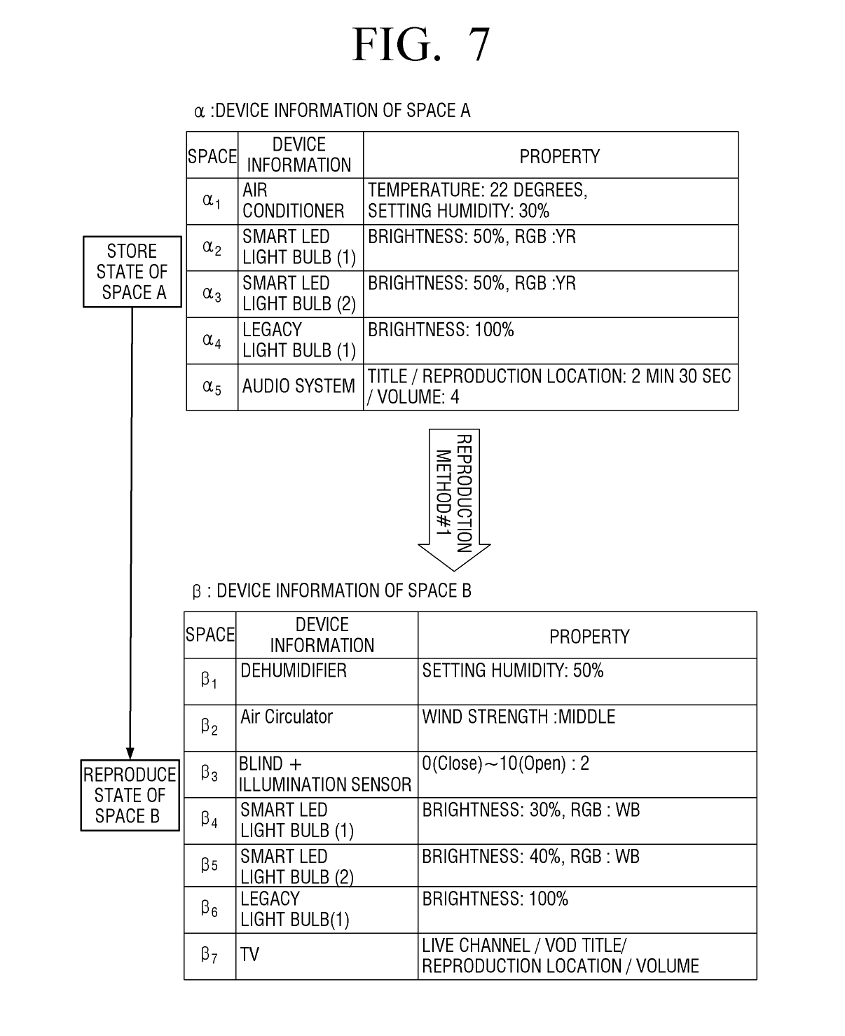

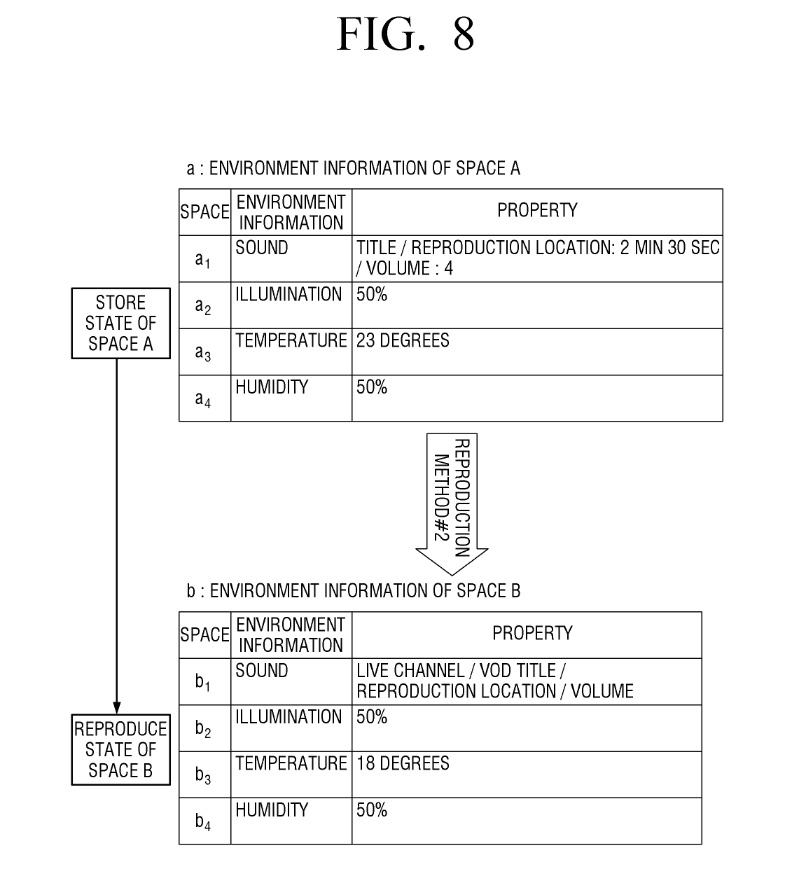

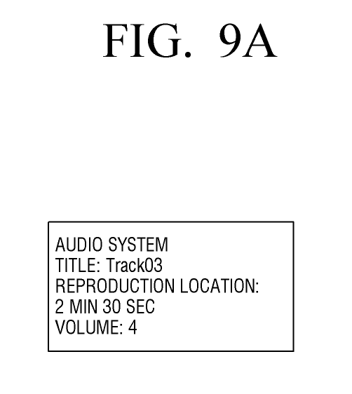

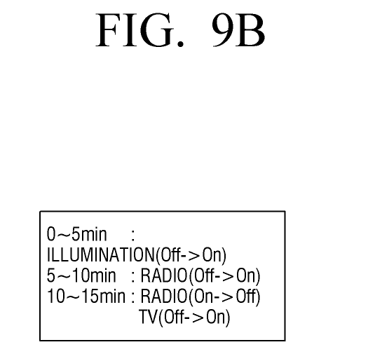

FIG. 5 is a block diagram of a structure of the user device control apparatus 120 of FIG. 1. FIG. 6 is a diagram of a control method of FIG. 5. FIGS. 7 and 8 are diagrams for describing a state reproduction of a space state reproducer of FIG. 6. FIGS. 9A and 9B are diagrams for describing an information input process of a user.

For convenience of description, referring to FIGS. 1 and 5, the user device control apparatus 120 according to an embodiment of the present disclosure may include a part or a whole of the space state reproducer 500 and a storage 510, whereby the user device control apparatus 120 may be configured by omitting the storage 510 or combining the storage 510 into a different element such as the space state reproducer 500. For sufficient understanding of the present disclosure, it will be described that the user device control apparatus 120 includes the storage 510 and the space state reproducer 500.

The space state reproducer 500 may acquire information regarding operation states of the user apparatuses 100-1 and 100-2 such as an air conditioner and an audio device that are provided in a space of the space state reproducer 500 and environment states such as illumination and humidity according to an illumination sensor and a humidity sensor, etc. through communication with the zone connectors 110-1 and 110-2 of each space and store the information in the storage 510. The information may be stored, for example, after a certain period of time elapses when a representative user of each space leaves the corresponding space.

When the user enters or moves to an arbitrary space, the space state reproducer 500 may determine whether to reproduce the corresponding space state based on user information detected by the zone connectors 110-1 and 110-2. For example, if a detected user is determined as a representative user of the corresponding space, the space state reproducer 500 may determine whether to reproduce a state according to user entry or a state according to user movement. For example, in a case where user information of the representative user is designated in an adjacent space, and the user moves from the adjacent space, the space state reproducer 500 may reproduce a state of a space before the user movement. To this end, the space state reproducer 500 may search for state information stored in the storage 510 and determine whether to reproduce the state in a moved space. In other words, in a case where the same device or a device of the same property is present, the space state reproducer 500 may be capable of reproducing the same state. However, in a case where the same device or the device of the same property is not present, the space state reproducer 500 may determine a replacement device(s) to reproduce the state of the space before movement in a similar way through the replacement device(s). During this process, the space state reproducer 500 may use information previously stored in the storage 510.

FIGS. 7 and 8 assume a case where the representative user moves from the space A to the space B. When the representative user moves from the space A to the space B, the space state reproducer 500 may reproduce device information of the space A or environment information in the space B. During a reproduction process, as described above, in a case where the same device or the device of the same property is not present, the space state reproducer 500 may reproduce a previous state by using the replacement device(s). If the device is an air conditioner for example, the space state reproducer 500 may determine if another air conditioner is present as the same device in the space to be reproduced and if no air conditioner is present, the space state reproducer 500 may determine if a dehumidifier of the same property is present and if no device of the same property is present, the space state reproducer 500 may determine a replacement device(s) and reproduce the previous state.

The space state reproducer 500 may include a CPU and a memory and store programs for performing the above operations in its memory. The stored programs may be executed under control of the CPU. The space state reproducer 500 may be implemented as software in the form of a recording medium. The software may perform all functions of the CPU and the programs stored in the memory.

The storage 510 stores the information regarding the operation states of the user apparatuses 100-1 and 100-2 provided in each space and the environment states such as illumination and humidity. The stored state information may be classified and stored in relation to the zone connectors 110-1 and 110-2. If the zone connectors 110-1 and 110-2 determine that the representative user does not enter the space after a certain period of time when leaving the space of the representative user and requests the user device control apparatus 120 to store the state information, the user device control apparatus 120 may match the state information and the corresponding space with each other and store the state information in the storage 510. Thereafter, when the user is determined to have re-entered the space, the user device control apparatus 120 may provide the stored state information according to a request of the zone connectors 110-1 and 110-2. The storage 510 may store the state information in the form of for example, a lookup table such as Table 3 and Table 4 below. Table 3 and Table 4 respectively show device information and environment information of the Space A.

TABLE 3

| Space | Device Information | Property |
|---|---|---|
| | Air conditioner | Setting temperature: 22 degrees, |
| | | setting humidity: 30% |
| | Smart LED light bulb (1) | Brightness |
| | Smart LED light bulb (2) | Brightness |
| | Legacy light bulb (1) | Brightness |
| | Audio system | Title/reproduction location: |
| | | 2 min 30 sec/volume |

TABLE 4

| | | |
|---|---|---|
| | Environment | |
| Space | Information | Property |

| | |
|---|---|
| Sound | Title/reproduction location: |
| | 2 min 30 sec/volume |
| Illumination | Brightness 50% |
| Temperature | 23 degrees |
| Humidity | 50% |

Although such information may be automatically stored, as shown in FIGS. 9A and 9B, the information may be stored through a user interaction. For example, the user may acknowledge a preset state of each space through a mobile terminal apparatus of the user. Correction may be possible through the mobile terminal apparatus. The correction may be performed by providing the preset state on a screen of the mobile terminal apparatus in the form of a user interface (UI) screen (i.e., a menu screen or a popup window). As shown in FIG. 9A, the user may input state information of an audio device in detail. As shown in FIG. 9B, the user may also input state information such as illumination, etc. Based on the above, the storage 510 may further store a program for providing the present space based on a device control service.

Although the information stored in the storage 510 may be changed according to a location movement of the representative user, the information may remain in an initial status. In other words, when the representative user moves from the space A to the space B, the user device control apparatus 120 may generate new state information for reproducing a state of the space A in the space B based on state information of the space A and the state information of the space B and provide the new state information to the zone connector 110-1 of the space A without storing the new state information, and thus the information may vary according to the intent of a designer. Thus, the embodiment of the present disclosure is not limited to whether the information is stored or not.

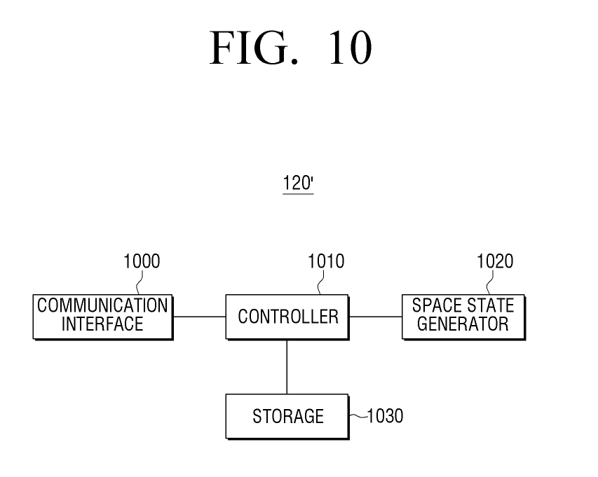

FIG. 10 is a block diagram of another structure of the user device control apparatus of FIG. 1.

For convenience of description, referring to FIGS. 1 and 10, user device control apparatus 120′ according to another embodiment of the present disclosure may include a part or a whole of a communication interface 1000, a controller 1010, a space state generator 1020, and a storage 1030, whereby the user device control apparatus 120′ may be configured by omitting an element such as the space state generator 1020 or combining elements such as the storage 1030 into a different element, such as the controller 1010, etc. For sufficient understanding of the present disclosure, the user device control apparatus 120′ will be described as a whole.

The communication interface 1000 may perform communication with the zone connectors 110-1 and 110-2 of FIG. 1 to collect various types of information provided by the zone connectors 110-1 and 110-2, for example, state information of the user apparatuses 100-1 and 100-2 and transfer the information to the controller 1010. In a case where a representative user of each space is detected, the communication interface 1000 may also receive an apparatus ID of a mobile terminal apparatus of the representative user and transfer the apparatus ID to the controller 1010.

The communication interface 1000 may provide space based device control services requested by the mobile terminal apparatus of the representative user according to an embodiment of the present disclosure. For example, in a case where the representative user changes state information of the user apparatuses 100-1 and 100-2 provided in a space of the representative user, the communication interface 1000 may change the state information and correct the state information by acknowledging stored information.

The controller 1010 may control general operations of the communication interface 1000, the space state generator 1020, the storage 1030, etc. that are included in the user device control apparatus 120′. For example, if the state information of the user apparatuses 100-1 and 100-2 for each space is received, the controller 1010 may store the state information in the storage 1030. If there is a request for the stored information, the controller 1010 may provide the corresponding information. The request may arrive at a time when the representative user of each space newly enters the space of the representative user or moves to adjacent spaces. During this process, the controller 1010 may perform various operations. For example, the controller 1010 may control an operation relating to detecting whether the same device is present, when the same device is not present, whether a same property or replacement device operates, etc. as determined by the space state generator 1020.

When the user device control apparatus 120′ first operates, the controller 1010 may download a program for performing the operation stored in the space state generator 1020, store the program in an internal memory, and execute the stored program. The controller 1010 may include a CPU for executing the program and memory for storing the program. The memory may be a recording medium.

The controller 1010 and the space state generator 1020 of FIG. 10 may perform the same operation as the space state reproducer 500 of FIG. 5. However, there is a difference as to whether the controller 1010 and the space state generator 1020 of FIG. 10 are physically separated from each other. The program included in the space state generator 1020 may be implemented in the form of hardware with respect to a specific module. Thus, the embodiment of the present disclosure is not limited to the program.

The storage 1030 may not be different from the storage 510 of FIG. 5, and thus the description of the storage 510 may replace a description of the storage 1030.

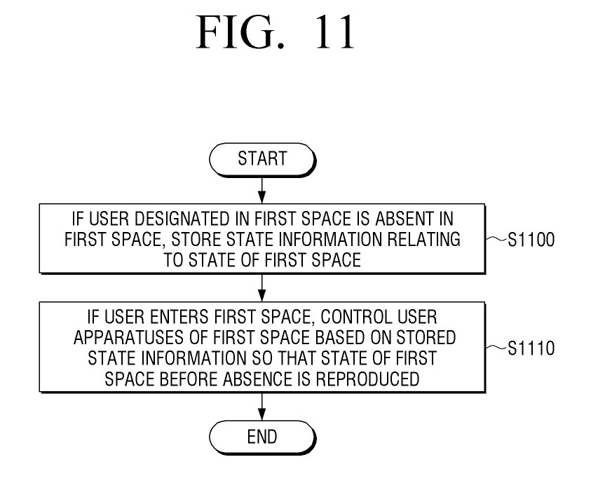

FIG. 11 is a flowchart of a process of controlling the user device control apparatus 120, according to an embodiment of the present disclosure.

For convenience of description, referring to FIGS. 1 and 11, the user device control apparatus 120 according to an embodiment of the present disclosure may store first space information of at least one state among operation states of the user apparatuses 100-1 and 100-2 provided in a first space and environment information of the first space in step S1100. The first space information may be stored periodically when there is a change in the operation states of the user apparatuses 100-1 and 100-2 or there is a change in the environment information, and may be stored finally after a certain period of time after a user leaves the corresponding space. At this time, the user apparatuses 100-1 and 100-2 of the corresponding space may be turned off.

Thereafter, if the user enters the first space, the user device control apparatus 120 may control the user apparatuses 100-1 and 100-2 of the first space to have at least one state of the operation states and the environment state based on the stored first space information in step S1110. In other words, the user device control apparatus 120 may determine whether the user enters the first space, when a representative user enters, may search for the pre-stored first space information based on apparatus IDs of the zone connectors 110-1 and 110-2 that manage the corresponding space, and provide searched state information. Such an operation may be performed in one program unit, and thus a program relating to step S1110 may be executed by being stored in a recording medium.

When the representative user does not newly enter and is determined to have moved from an adjacent second space, the user device control apparatus 120 may perform control to reproduce the same state as the second space. Since this was described above, further description is omitted.

FIG. 12 is a flowchart of a process of reproducing a state based on a state (target set) value for each device.

For convenience of description, referring to FIG. 12, FIG. 1, and Table 3, if a user, i.e., a representative user, moves from the space A to the space B, the user device control apparatus 120 according to an embodiment of the present disclosure may start a configuration device contrast of the space A and the space B in step S1200.

During this process, the user device control apparatus 120 may search for the same device in step S1210, and in a case where the same device is not searched, the user device control apparatus 120 may search for a device of the same property in step S1220. In a case where the device of the same property is not searched, the user device control apparatus 120 may search for a device of a similar property by referring to a stored similar property device list in step S1230.

For example, as shown in FIG. 3, the user device control apparatus 120 may search for an air conditioner different from an air conditioner of the space A, and if no air conditioner is present, search for and select a dehumidifier of the same property for adjusting humidity. If no device of the same property for adjusting temperature is present, the user device control apparatus 120 may search for and select a window blind apparatus and a fan.

According to each search result, the state for each device may be reproduced. During this process, each reproduction result may be stored. However, in a case where no device of the similar property is also searched, the user device control apparatus 120 may register that there is no reproduction method and inform the user of such condition in steps S1240-S1270.

If information of all devices is searched through such a process, the user device control apparatus 120 may reproduce a state of the space A in the space B in step S1290. That is, the user apparatuses 100-2 of the space B may be controlled.

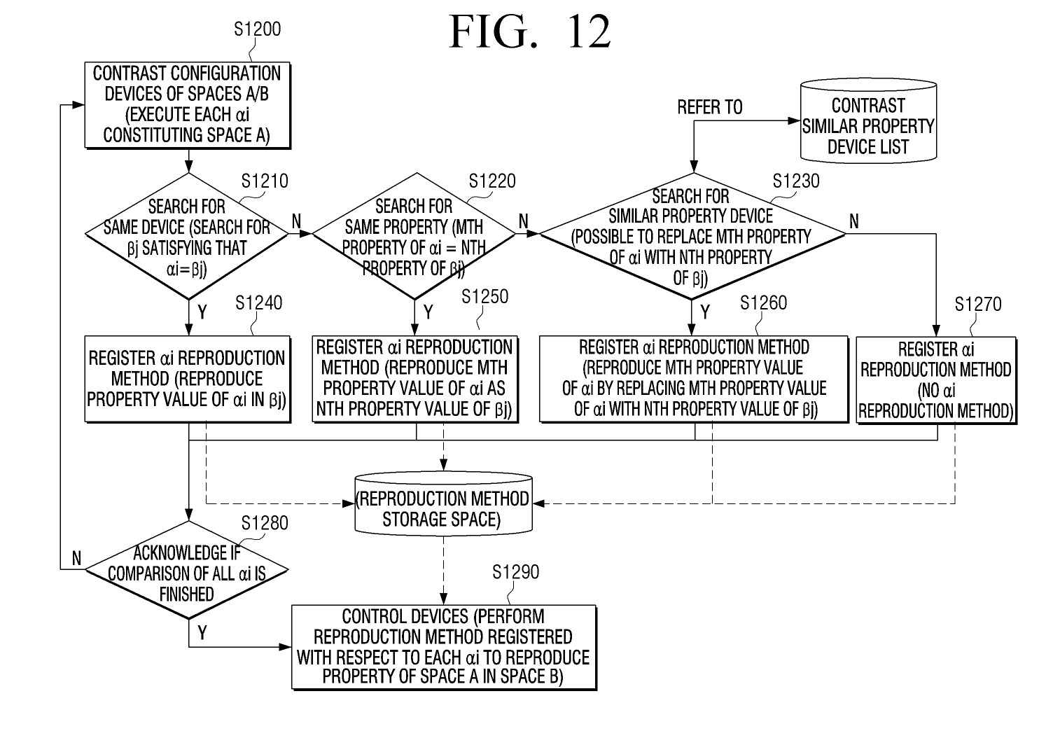

FIG. 13 is a flowchart of a process of reproducing a state based on an environment state value for each space.

For convenience of description, referring to FIG. 13, FIG. 1, and Table 4, the user device control apparatus 120 according to an embodiment of the present disclosure may start a configuration device contrast process of the space A and the space B in step S1300.

The user device control apparatus 120 may search for information of the same environment state in step S1310, and as a result of the search, if the information of the same environment state is searched, compare property values in step S1320. As a result of comparison, if the property values are not identical, the user device control apparatus 120 may search for a property change device to make the corresponding values identical in step S1330.

According to each search and comparison result, the user device control apparatus 120 may reproduce the state for each environment. Each reproduction result may be stored in steps S1340 and S1350. In a case where no property change device is searched, the user device control apparatus 120 may register that reproduction is unavailable and inform the user of such condition in step S1360.

If the search and comparison with respect to information of all environments are completed through such a process in step S1370, the user device control apparatus 120 may reproduce an environment state of the space A in the space B in step S1380. In other words, the user apparatuses 100-2 of the space B may be controlled.

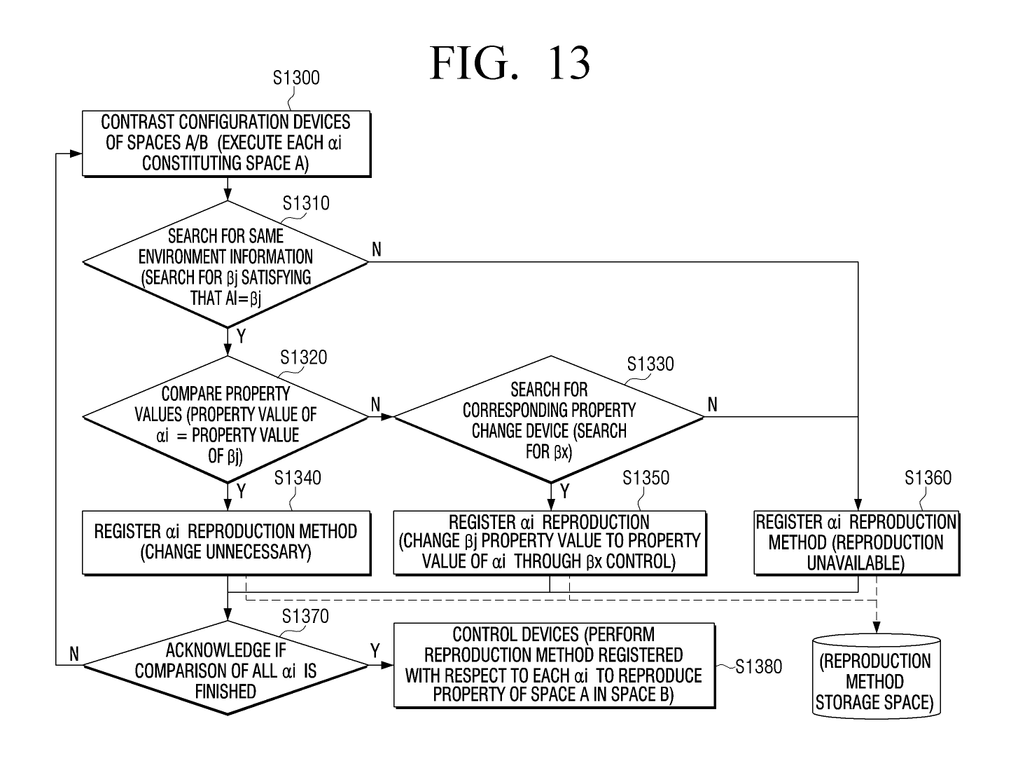

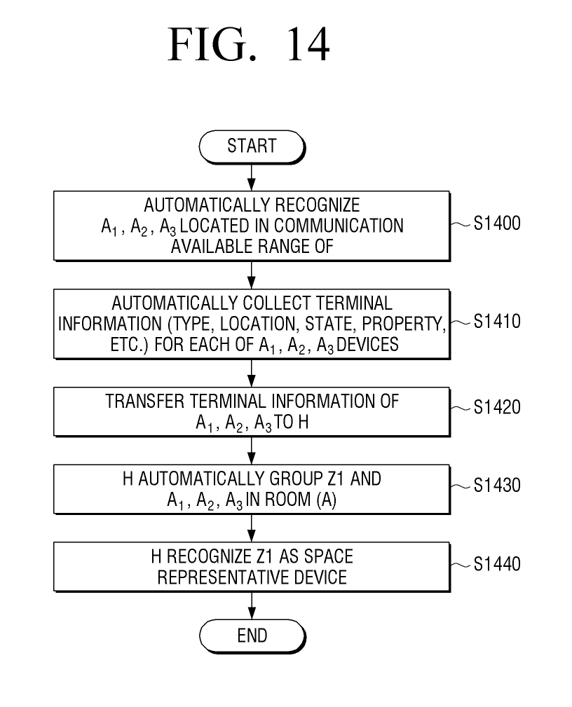

FIG. 14 is a flowchart of a process of automatically grouping devices for each space.

For convenience of description, referring to FIGS. 1 and 14, the zone connector 110-1 of the space A according to an embodiment of the present disclosure may automatically recognize the user apparatuses 100-1 located within a communication range in step S1400. In other words, the zone connector 110-1 and the user apparatuses 100-1 may communicate each other's presence when initially installed.

The zone connector 110-1 collects terminal information of the user apparatuses 100-1 that are automatically recognized in step S1410. In this regard, the terminal information includes information such as a type, a location, a state, a property, etc.

If a collection process is finished, the zone connector 110-1 transmits the terminal information to the user device control apparatus 120 such as a home server H in step S1420.

Accordingly, the user device control apparatus 120 automatically groups the plurality of user apparatuses 100-1 in the space A in relation to the zone connector 110-1 of the space A in step S1430.

During this process, the user device control apparatus 120 recognizes the zone connector 110-1 of the space A as a representative device of the space A in step S1440.

An automatic grouping process may be performed in a space B similar to space A, and thus further description is omitted.

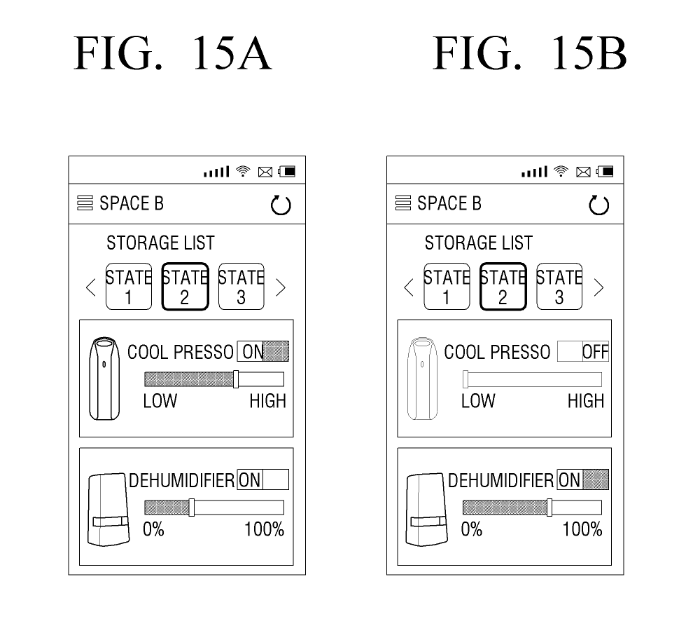

FIGS. 15A and 15B are diagrams for describing a process of acknowledging and correcting a reproduction state.

For convenience of description, referring to FIGS. 1, 15A and 15B, a mobile terminal apparatus, for example, a portable phone owned by a representative user of the space B, according to an embodiment of the present disclosure may display states of the user apparatuses 100-2 currently reproduced in a space of the mobile terminal apparatus according to a user request as shown in FIG. 15A.

If a user selects a state 2 on a screen of FIG. 15A, operation states of the related user apparatuses 100-2 or an environment state may be displayed. For example, if it is assumed that the state 2 is a state relating to humidity, states of a small cooling device and a dehumidifier that are provided in the space B are displayed on the screen. The user may control using the displayed screen as shown in FIG. 15B, thereby stopping an operation with respect to a specific device.

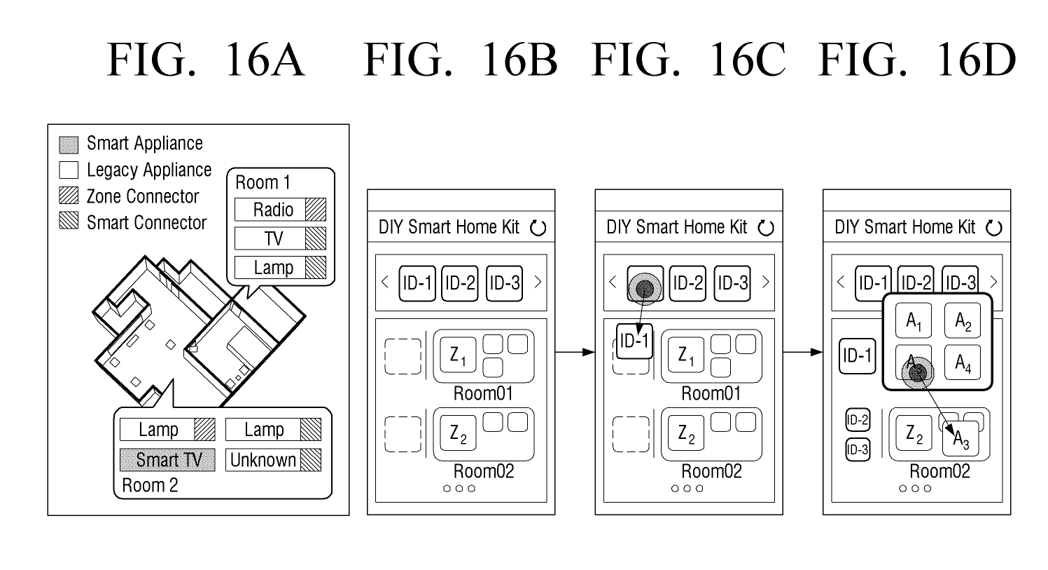

A mobile terminal apparatus such as the portable phone of the representative user or a laptop computer may execute, for example, an internally stored application and acknowledge a service performed in the space of the mobile terminal apparatus, i.e. a control state of a user device. Various screens such as displaying the above-described grouping information, etc. may be displayed. This will be described with reference to FIG. 16.

FIGS. 16A through 16D are diagrams for describing a regrouping process when there is an error in the automatic grouping process.

As shown in FIGS. 16A through 16D, representative users of each space may acknowledge grouped devices in a home of the representative users through separate applications.

For example, if a user selects a menu icon for a space based device control service displayed on a background screen, a screen may be displayed as shown in FIG. 16A, and after an automatic grouping operation is performed, a screen may be displayed as shown in FIG. 16B. In other words, a mobile terminal apparatus of the user may automatically group devices near the zone connector 110-1 of the space A through automatic recognition, divide the space A, and display the screen of FIG. 16B. For example, such an operation may be performed in various cases like the zone connector 110-1 is initially installed or a location of the zone connector 110-1 is changed, etc.

If the screen of FIG. 16B is displayed, the user may designate the representative users of each space as shown in FIG. 16C. When it is determined that there is an error in a space to which each of the automatically grouped devices belongs as shown in FIG. 16D, the user may change the space to which the corresponding device belongs through a drag operation, etc.

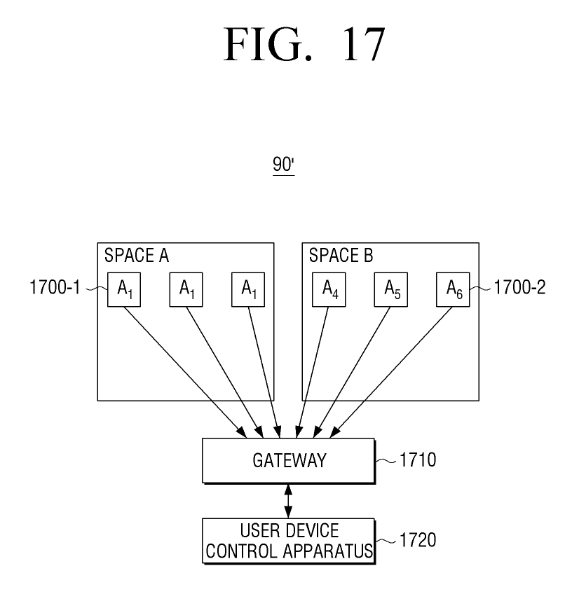

FIG. 17 is a block diagram of an example of a system of FIG. 1.

As shown in FIG. 17, a user device control system 90′ according to an embodiment of the present disclosure includes a plurality of user apparatuses 1700-1 and 1700-2, a gateway 1710, and a user device control apparatus 1720.

Upon comparing FIG. 17 and FIG. 1, a space may be automatically divided through the zone connectors 110-1 and 110-2 provided in each space in FIG. 1, whereas, in a case where one gateway is present at home, the space may be divided based on the strength of a signal in FIG. 17.

In this case, the gateway 1710 may divide each space according to the strength of the signal and automatically provide a representative ID. In FIG. 1, the user device control apparatus 120 may divide a space by using IDs of the zone connectors 110-1 and 110-2 of each space as representative devices, whereas in FIG. 17, the space may be divided based on a randomly generated ID. Alternatively, one of the plurality of user apparatuses 1700-1 may be designated as a representative device. Thus, if a user moves, the gateway 1710 may divide the space through information of the user apparatuses 1700-1 provided along with an apparatus ID of a mobile terminal apparatus. A space state may be reproduced in this way. In this regard, an information provider may be the mobile terminal apparatus.

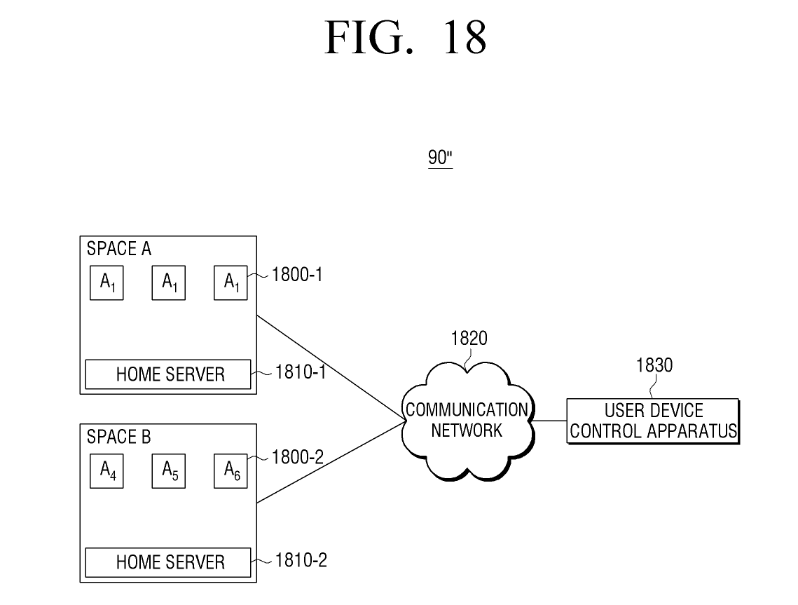

FIG. 18 is a block diagram of another example of a system of FIG. 1.

As shown in FIG. 18, a user device control system 90″ according to another embodiment of the present disclosure includes a plurality of user apparatuses 1800-1 and 1800-2, a home server 1810, an office server 1810-2, a communication network 1820, and a user device control apparatus 1830.

Upon comparing FIG. 18 and FIG. 1, the space A and the space B have spaces adjacent at home in FIG. 1, whereas the space A is a space at home, and the space B is a personal office space in FIG. 18.

Therefore, the user device control apparatus 1830 according to an embodiment of the present disclosure may reproduce a space state in a case where a user moves from an office space to a home space. In this regard, the user device control apparatus 1830 may be a cloud server.

The communication network 1820 may include both wired and wireless communication and may further include an access point such as Wi-Fi installed in a house or office.

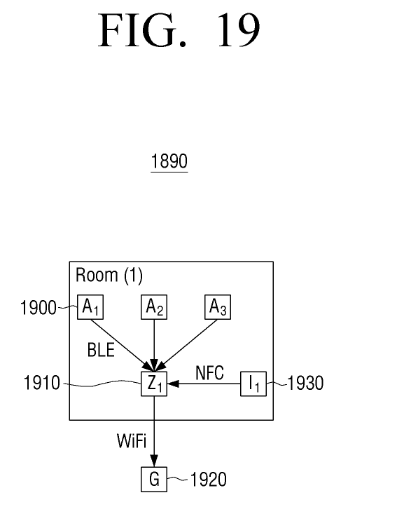

FIG. 19 is a block diagram of a user device control system 1890 according to an embodiment of the present disclosure.

The user device control system 1890 of FIG. 19 may a part or a whole of user apparatuses 1900, a zone connector 1910, a gateway 1920, and a mobile terminal apparatus 1930, and may further include a user device control apparatus, whereby the user device control system 1890 may be configured by omitting an element such as the zone connector 1910, the gateway 1920, or the user device control apparatus or combining elements such as the gateway 1920 into a different element such as the user device control apparatus, etc. For convenience of description, only differences between FIGS. 1 and 19 are described.

Upon comparing the user device control system 1890 of FIG. 19 with the user device control system 90 of FIG. 1, the gateway 1920 may replace the user device control apparatus 120 of FIG. 1 or may be between the zone connector 1910 and the user device control apparatus 120.

The zone connector 1910 may perform Bluetooth communication with the user apparatuses 1900 of each space, may perform Wi-Fi communication with the gateway 1920, and may perform near field communication (NFC) with the mobile terminal apparatus 1930. For example, the zone connector 1910 may perform an operation of setting the mobile terminal apparatus 1930 as a representative device through NFC. Accordingly, a space entry or movement of a user may be sensed over short ranges.

Based on the above, the zone connector 1910 according to an embodiment of the present disclosure may include a Bluetooth communication module, an NFC communication module, a Wi-Fi communication module, etc. and may further include a biometric recognition module to perform various types of communication.

Although the user device control system 1890 according to an embodiment of the present disclosure does not perform non-contact communication by using the mobile terminal apparatus 1930, since a fingerprint recognition technology using a fingerprint of the user, as a biometric recognition technology, may be used to sense the space entry or movement of the user, the embodiment of the present disclosure is not limited thereto.

The user apparatuses 1900, the zone connector 1910, and the gateway 1920 of FIG. 19 are not greatly different from the user apparatuses 100-1 and 100-2 and the zone connectors 110-1 and 110-2 of FIG. 1 and the gateway 1920 of FIG. 17, and thus the descriptions of the user apparatuses 100-1 and 100-2 and the zone connectors 110-1 and 110-2 of FIG. 1 and the gateway 1920 of FIG. 17 may replace descriptions of the user apparatuses 1900, the zone connector 1910, and the gateway 1920 of FIG. 19.

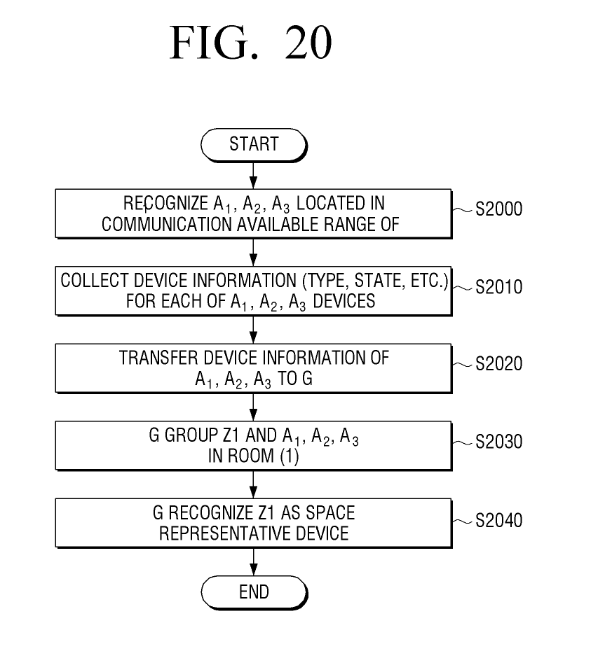

FIG. 20 is a flowchart of a device grouping process for each space using a system of FIG. 19.

Upon comparing the device grouping process of FIG. 20 and a grouping process of FIG. 14, the device grouping process of FIG. 20 is different from the grouping process of FIG. 14 in that the gateway 1920 of FIG. 19 performs the same operation as a home server of FIG. 14.

With the exception of the above, the device grouping process of FIG. 20 is not greatly different from the grouping process of FIG. 14, and thus the description of the grouping process of FIG. 14 may replace a description of the device grouping process of FIG. 20.

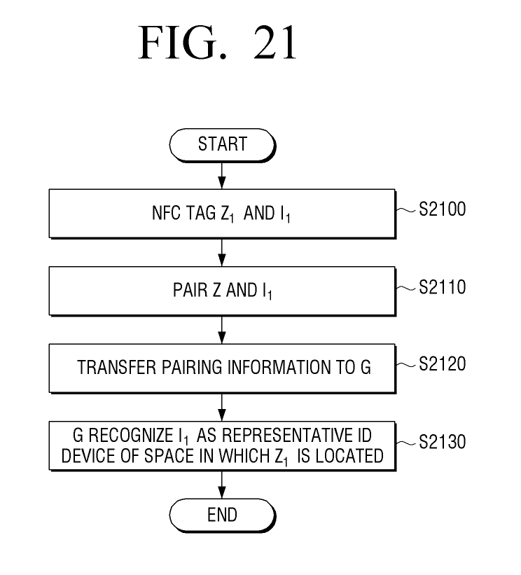

FIG. 21 is a flowchart of a process of setting a representative device for each space using a system of FIG. 19.

For convenience of description, referring to FIGS. 19 and 21, the zone connector 1910 of FIG. 19 tags the mobile terminal apparatus 1930 such as a smart phone or a wearable apparatus through NFC in step S2100.

The zone connector 1910 performs a pairing operation with the mobile terminal apparatus 1930 and transfer pairing information to the gateway 1920 in step S2110 and S2120.

The gateway 1920 sets the mobile terminal apparatus 1930 as a representative device of a space in which the zone connector 1910 is located in step S1230.

When the mobile terminal apparatus 1930 set as the representative device, is recognized through the zone connector 1910, the gateway 1920 may sense entry of a user or movement.

When entry of the designated representative user or movement is sensed, the gateway 1920 may provide state information for controlling the user apparatus 1900 to the user apparatus 1900 through the zone connector 1910.

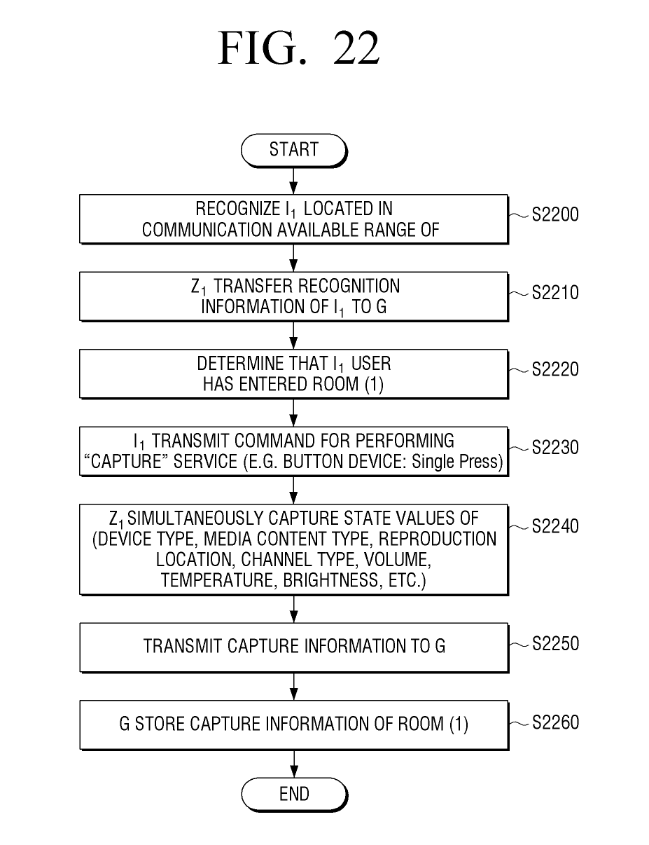

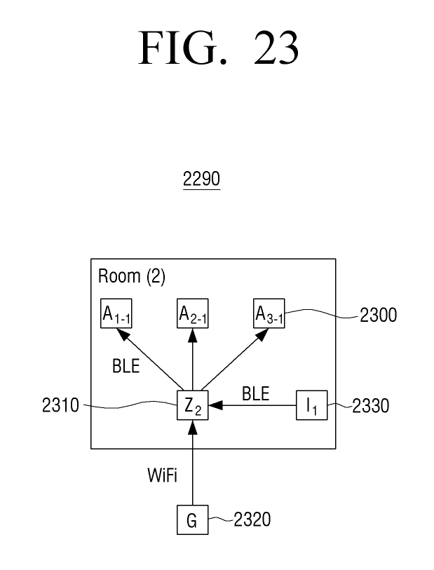

FIG. 22 is a flowchart of a process of simultaneously storing states of devices in an arbitrary space using a system of FIG. 19.

For convenience of description, referring to FIGS. 19 and 22, the zone connector 1910 according to an embodiment of the present disclosure recognizes a mobile terminal apparatus 1930 located in communication range in step S2200.

The zone connector 1910 provides recognition information of the recognized mobile terminal apparatus 1930, for example, apparatus information, to the gateway 1920 in step S2210.

Accordingly, the gateway 1920 (or a separate user device control apparatus connected to the gateway 1920) determines entry of a representative user in step S2220.

Thereafter, a user gives a command to store state information through the mobile terminal apparatus 1930 in step S2230. For example, to input a user command, an external button, etc. may be pressed, a “capture” command may be spoken after a voice function is activated, or an icon mapped with a corresponding function on a screen may be tapped. In addition, various methods may be possible, and thus the embodiment of the present disclosure is not particularly limited thereto. For example, it was described above that the mobile terminal apparatus 1930 automatically stores the state information in a case where there is no re-entry after a certain period of time when leaving the corresponding space.

If it is determined whether to store the state information, the zone connector 1910 simultaneously captures the state information, in other words, simultaneously collects the state information, and transmits the collected capture information to the gateway 1920 in steps S2240 and S2250. The state information may include media content.

The gateway 1920 receives and stores capture information of Room 1 transmitted from the zone connector 1910 in step S2260.

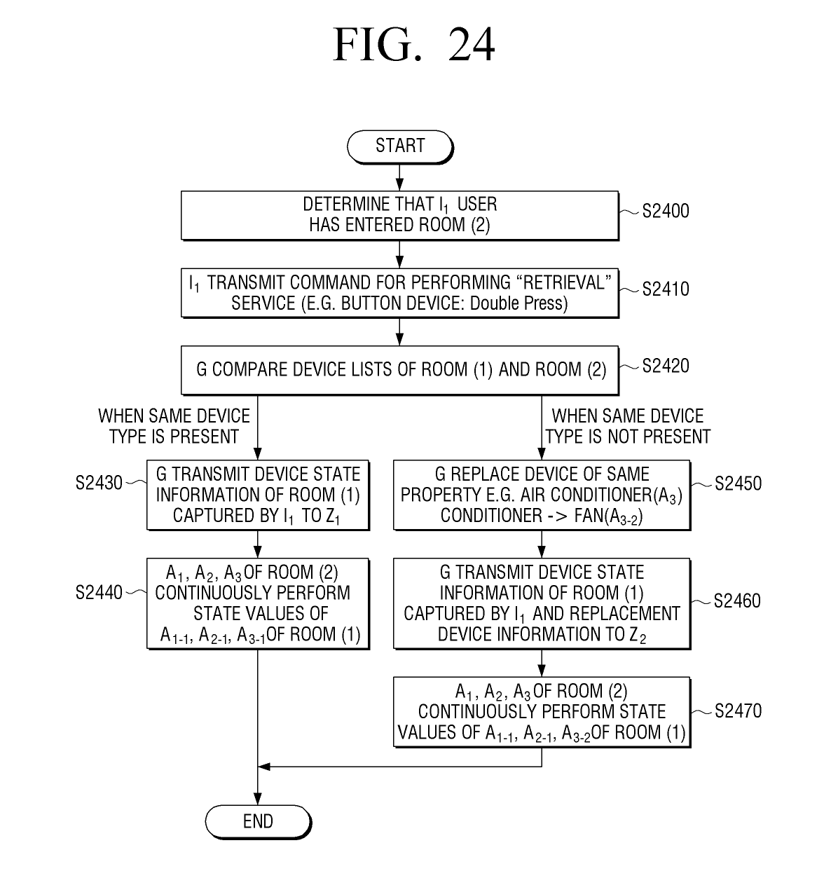

FIG. 23 shows the same system as shown in FIG. 19 and is a block diagram of an example of a user device control system for simultaneously reproducing device states. FIG. 24 is a flowchart of a process of simultaneously reproducing device states using the system of FIG. 23.

For convenience of description, referring to FIGS. 23 and 24, a zone connector 2310 of FIG. 23 constituting a user device control system 2290 determines that a mobile terminal apparatus 2330 has entered Room 2 in step S2400.

For example, if a retrieval service is on a screen of the mobile terminal apparatus 2330, the mobile terminal apparatus 2330 transmits a user command for performing the retrieval service to the zone connector 2310 via a user interface. For example, after an external button is continuously pressed twice or a voice function is activated in order to distinguish the user command from a storage command, “retrieval” may be spoken, and an icon mapped with a corresponding function may be tapped on a screen. In this connection, if the zone connector 2310 recognizes the mobile terminal apparatus 2330, a state may be automatically implemented, but the embodiment of the present disclosure may not be limited thereto.

If a user service request is present, for example, the gateway 2320 determines whether the same device is present based on the stored state information relating to Room 1 and Room 2 in step S2420.

As a result of determining the same device is present, in operations 52430 and 52440, the state information may be searched for and transmitted to the user device 2300 through the zone connector 2310.

If the same device is not present, in steps S2450 and S2460, a device of the same property or a replacement device may be determined, and preset (or pre-stored) state information transmitted to the user apparatus 2300 through the zone connector 2310 according to a determination result. Since this was described above, a further description is omitted.

Accordingly, the user apparatus 2300 operates according to the received state information in step S2470.

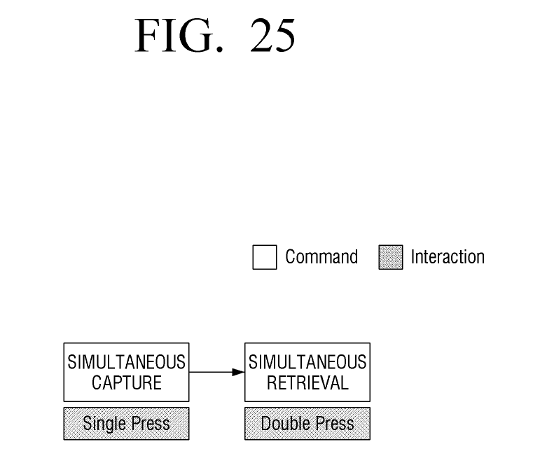

FIGS. 25 through 27 are diagrams of various examples of inputting a user command for storing state information of a user apparatus and reproducing a state of the user apparatus.

As described with reference to FIGS. 22 and 24 above, a user may give a command to store state information according to an operation of pressing a button once as shown in FIG. 25 through the mobile terminal apparatuses 1930 and 2330 and may request a retrieval service of the state information according to a double press operation of pressing the button twice.

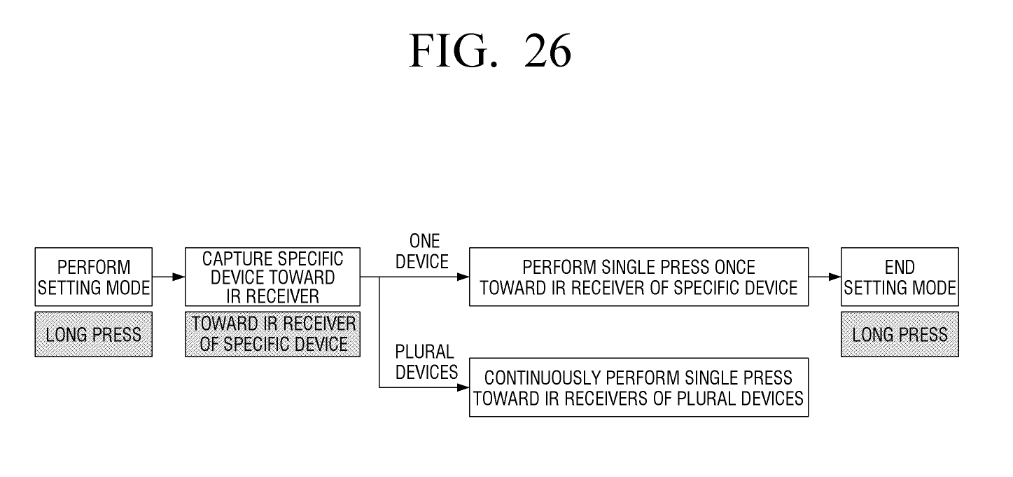

As shown in FIG. 26, in a case where a specific button is long pressed or an icon mapped to a specific function is long pressed, an operation of capturing or searching for state information of the specific device may be performed through a long tap. For example, if a list of user apparatuses is displayed on a screen through the long tap, it may be possible to store or search for the state information by selecting a specific device.

Alternatively, it may also be possible to generate a trigger, i.e. a trigger signal, to select devices, i.e. user apparatuses, through the long tap of FIG. 26, and store a set value of a corresponding device through a single press operation of pressing a specific button of the mobile terminal apparatuses 1930 and 2330 of the user toward, for example, an IR receiver, of each user apparatus. In this connection method, various modifications may be possible, and thus the embodiment of the present disclosure may not be limited thereto.

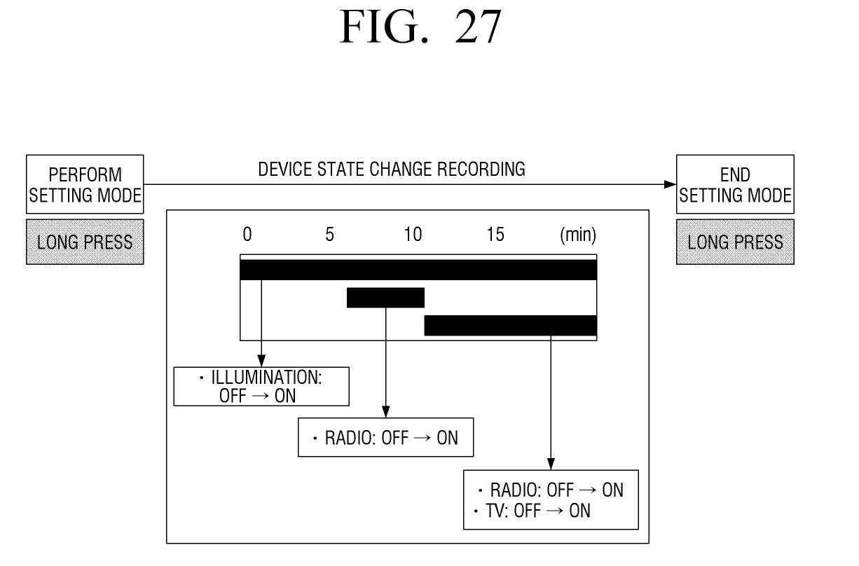

Furthermore, the user may capture a state change of a user apparatus or content according to a time variation as shown in FIG. 27. In other words, it may be possible to not only store a state of a user apparatus, etc., for example, at a specific time but also store states of user apparatuses or a state change of content in real time.

The user may perform the long tap for setting a device state, may store a sequential variation state of a user apparatus that occurs before ending in the same way, and may set the sequential variation state as, for example, a mode A. For example, if the user stores the state change of the user apparatus that occurs from 8 a.m. to 11 a.m. as the mode A, for example, the gateway 2320 of FIG. 23 may perform the mode A according to a user request to reproduce the same operation.

Various UI screens and a user interface may be realized, and thus are not be limited thereto. However, the same reproduction may be possible with respect to user apparatuses operating according to the time variation in an embodiment of the present disclosure.

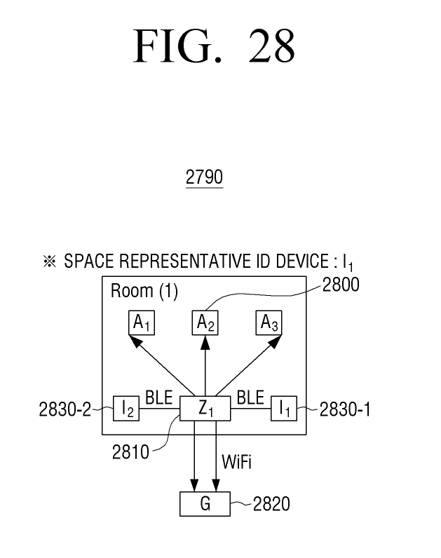

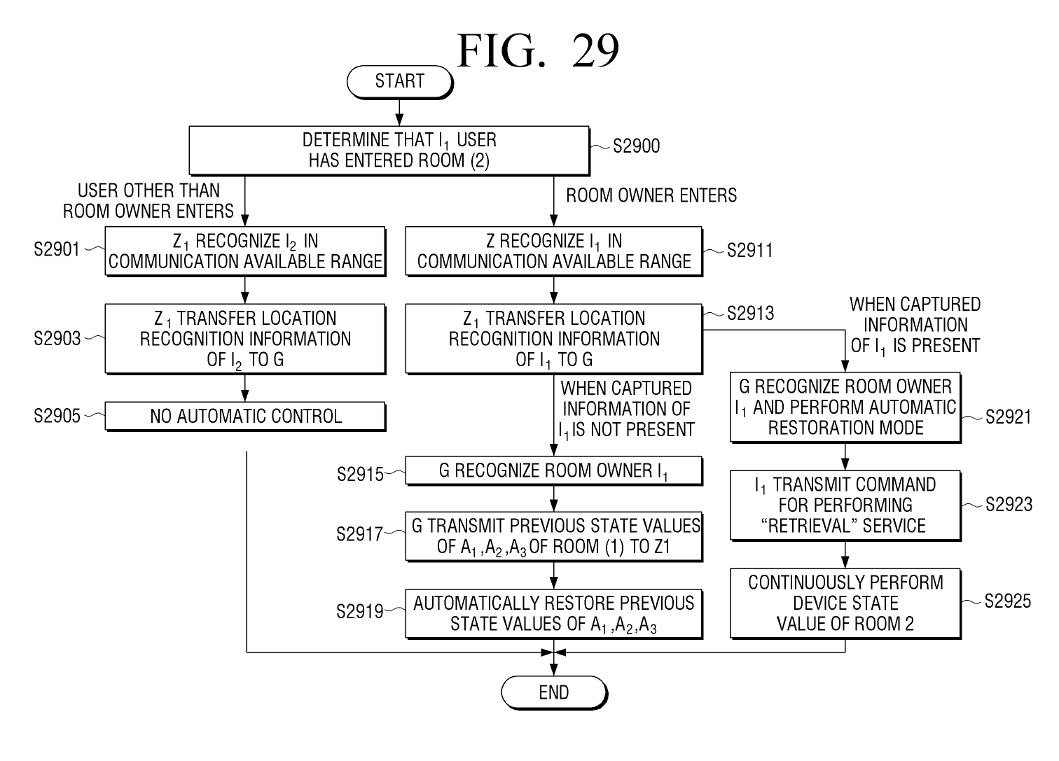

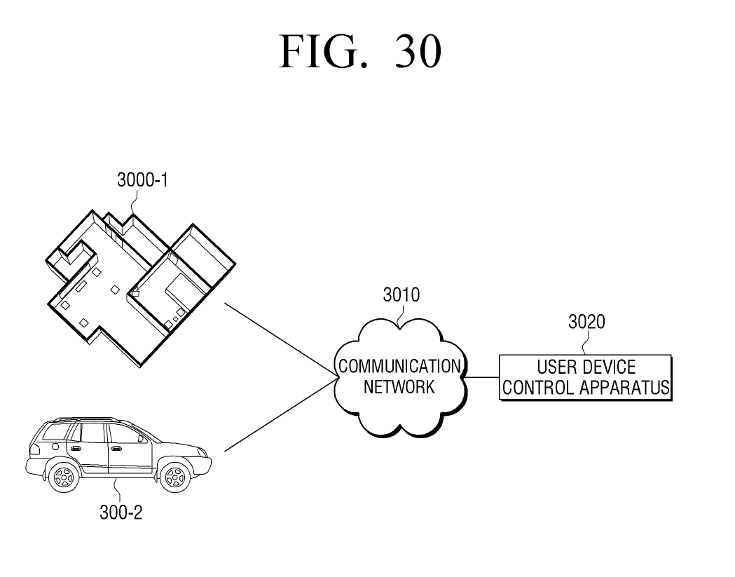

FIG. 28 is a block diagram of a user device control system for a customized service for each user. FIG. 29 is a flowchart of a service process using a system of FIG. 28.

Referring to FIGS. 28 and 29, when a mobile terminal apparatus 2830-2 enters Room 1 or moves from another space, if it is determined that the mobile terminal apparatus 2830-2 is not a designated representative user, a gateway 2820 constituting a user device control system 2790 of FIG. 28 may not perform a separate control operation for controlling the user apparatus 2800 in steps S2900-S2905.

If the representative user enters or moves to a space of the representative user, the gateway 2820 performs a process of determining entry or movement of the representative user in steps S2911 and S2913. For example, the gateway 2820 determines if state information captured based on apparatus information of a mobile terminal apparatus 2830-1 is present.

As a result of the determination, if the captured state information is not present, the gateway 2820 performs step S2915 through step 2919.

However, if the captured state information is present, in other words, if movement from another space is determined, the gateway 2820 may reproduce a state of Room 2 according to a user request in steps S2921-S2925. Since this was sufficiently described above, a further description is omitted.

FIG. 30 is a diagram of a user device control system according to an embodiment of the present disclosure.

As shown in FIG. 30, when a user apparatus 300-2 that is the same as or similar to a user apparatus 3000-1 provided in a house space is present in a car space, the user device control system according to an embodiment of the present disclosure may reproduce a state of the house space.

For convenience of description, upon comparing FIG. 18 and FIG. 30, there is a difference that an office space of FIG. 18 is changed to a car of FIG. 30.

For example, in a case where an air conditioner or an audio device, etc. is provided in the house space, a state of the air conditioner or the audio device, etc. may be reproduced in the car space in a same or similar way. For example, if the air conditioner is present, temperature or wind speed, etc. may be reproduced, and music or volume, etc. of the audio device may be reproduced.

In this connection, when a user moves from the house space to the car space, location information may be provided to the user device control apparatus 3020 through a communication network 3010. For example, a mobile terminal apparatus owned by a car driver may transmit apparatus information of a car to the user device control apparatus 3020, and if the car driver is authenticated, it is possible to provide a service as described above.

Although an example of a car is shown in FIG. 30, since various spaces may be possible, an embodiment of the present disclosure may not be limited thereto. For example, an embodiment of the present disclosure may be applied to operation of a specific device such as a laptop computer.

The communication network 1820 of FIG. 18 and the communication network 3010 may include both wired and wireless communication networks. The wired communication network may include an Internet network such as a cable network or a public switched telephone network (PSTN), and the wireless communication network may include CDMA, WCDMA, GSM, evolved packet core (EPC), long term evolution (LTE), a Wibro network, etc. The communication network 3010 according to an embodiment of the present disclosure is not limited thereto and may be used in a cloud computing network, etc., under a cloud computing environment as an access network of a next generation mobile communication system that will be implemented in the future. In a case where the communication network 3010 is the wired communication network, an access point of the communication network 3010 may access a phone station. In a case where the communication network 3010 is the wireless communication network, the communication network 3010 may access an SGSN or a gateway GPRS support node (GGSN) operated by a communication company to process data or access various relay devices such as base station transmission (BTS), NodeB, e-NodeB, etc. to process the data.

The communication network 3010 may include the access point. The access point may include a small base station such as a femto or pico base station that may be installed in a building. The femto or pico base station may be divided according to the maximum number of user apparatuses that access the small base stations. The access point may include a near distance communication module for performing near distance communication such as Zigbee, Wi-Fi, etc. with a user apparatus. The access point may use TCP/IP or a real-time streaming protocol (RTSP) for wireless communication. In this regard, near distance communication may be performed by various standards such as Bluetooth, Zigbee, infrared (IrDA), radio frequency (RF) such as ultra high frequency (UHF) and very high frequency (VHF), ultra wide band (UWB) communication, etc., in addition to Wi-Fi. Accordingly, the access point may extract a location of a data packet, designate an optimal communication path with respect to the extracted location, and transfer the data packet to a next apparatus, for example, the user apparatus, along the designated communication path. The access point may share plural lines in a general network environment, and may include, for example, a router, a repeater, a relay device, etc.

In addition, other detailed descriptions relating to the user device control apparatus 3020, etc. are not greatly different from those of FIG. 18, and thus the descriptions of FIG. 18 will replace other detailed descriptions.

Although it has been described above that all the components of an embodiment of the present disclosure are coupled as a single unit or coupled to be operated as a single unit, the present disclosure is not limited to such an embodiment. Within the scope of the present disclosure, one or more components among the components may be selectively coupled to be operated as one or more units. Although each of the components may be implemented as an independent hardware, some or all of the components may be selectively combined with each other, so that they may be implemented as a computer program having one or more program modules for performing some or all of the functions combined in one or more hardware components. Code and code segments forming the computer program can be easily conceived by an ordinarily skilled person in the technical field of the present disclosure. Such a computer program may implement the embodiments of the present disclosure by being stored in non-transitory computer-readable media, and being read and executed by a computer.

The non-transitory computer readable recording media refers to media where data can be stored semi-permanently and is readable by a device, and not a medium which stores data for a short period of time such as a register, cache, and memory etc. More specifically, the aforementioned various programs may be stored in and provided by non-transitory computer readable recording medium such as a CD, non-volatile RAM, DVD, hard disk, blue ray disk, USB, memory card, and ROM, etc.

While this invention has been particularly shown and described with reference to certain embodiments thereof, it will be understood by those skilled in the art that various changes in form and details may be made therein without departing from the spirit and scope of the invention as defined by the appended claims. Therefore, the scope of the invention is defined not by the detailed description of the disclosure but by the appended claims and their equivalents, and all differences within the scope will be construed as being included in the present disclosure.

What is claimed is:

1. A user device control apparatus comprising:
a storage configured to store state information relating to a state of a first space;
a controller, if a user enters the first space, configured to search for the stored state information relating to the state of the first space; and
a communication interface configured to transmit the searched state information to a user apparatus of the first space to control the user apparatus based on the searched state information.

2. The user device control apparatus of claim 1, wherein the storage stores the state information of at least one state among an operation state of the user apparatus provided in the first space and an environment state of the first space.

3. The user device control apparatus of claim 1, wherein the storage stores the state information based on a zone connector installed in the first space and communication with the user apparatus.

4. The user device control apparatus of claim 1, wherein the storage is further configured to store state information relating to a space state of a second space, and
wherein the controller, if the user moves from the second space and enters the first space, is configured to control the user apparatus of the first space to reproduce the space state of the second space.

5. The user device control apparatus of claim 4, wherein the controller controls the user apparatus of the first space based on at least one piece of state information among the stored state information of the first space and the stored state information of the second space to reproduce the space state of the second space in a same or similar way to the state of the first space.

6. The user device control apparatus of claim 5, wherein the controller, if a user apparatus of a same property as the second space is not present in the first space is configured to select and control a user apparatus of a similar property in the second space to reproduce the state of the first space in a similar way to the space state of the second space.

7. The user device control apparatus of claim 4, wherein the storage stores the state information of the first space and the state information of the second space based on a signal strength of a gateway communicating with the user apparatus of the first space and the second space, and
wherein the controller is configured to determine the exit and entry of the first space and the second space based on apparatus information of the user apparatus of one of the first space and the second space provided from a mobile terminal apparatus of the user through the gateway.

8. The user device control apparatus of claim 1, wherein the controller determines the exit and entry of the first space and the second space based on a mobile terminal apparatus of the user.

9. A method of controlling a user device control apparatus, the method comprising:
storing state information relating to a state of a first space;
if a user enters the first space, searching for the stored state information relating to the state of the first space; and
transmitting the searched state information to a user apparatus of the first space to control the user apparatus based on the searched state information.

10. The method of claim 9, wherein storing the state information includes storing the state information of at least one state among an operation state of the user apparatus provided in the first space and an environment state of the first space.

11. The method of claim 9, wherein storing the state information includes storing the state information based on a zone connector installed in the first space and communicating with the user apparatus.

12. The method of claim 9, wherein storing the state information includes further storing state information of a space state of a second space, and
wherein the controlling includes, if the user moves from the second space and enters the first space, controlling the user apparatus of the first space to reproduce the space state of the second space.

13. The method of claim 12, wherein controlling the user apparatus includes controlling the user apparatus of the first space based on at least one piece of state information among the stored state information of the first space and the stored state information of the second space to reproduce the space state of the second space in a same or similar way to the state of the first space.

14. The method of claim 13, wherein controlling the user apparatus includes, if a user apparatus of a same property as the second space is not present in the first space, selecting and controlling a user apparatus of a similar property to the second space to reproduce the state of the first space in a similar way to the space state of the second space.

15. The method of claim 12, wherein storing the state information includes storing the state information of the first space and the state information of the second space based on a signal strength of a gateway communicating with the user apparatus of the first space and the second space, and
wherein controlling the user apparatus includes determining the exit and entry of the first space and the second space based on apparatus information of the user apparatus of one of the first space and the second space provided from a mobile terminal apparatus of the user through the gateway.

16. The method of claim 9, wherein controlling the user apparatus includes determining the exit and entry of the first space and the second space based on a mobile terminal apparatus of the user.

17. A non-transitory computer readable recording medium having recorded thereon a computer program which performs a user device control method, the user device control method comprising:
storing state information relating to a state of a first space;
if a user enters the first space, searching for the stored state information relating to the state of the first space; and
transmitting the searched state information to a user apparatus of the first space to control the user apparatus based on the searched state information.

18. The non-transitory computer readable recording medium of claim 17,
wherein storing the state information includes further storing state information of a space state of a second space, and
wherein controlling the user apparatus includes, if the user moves from the second space and enters the first space, controlling the user apparatus of the first space to reproduce the space state of the second space.

19. The non-transitory computer readable recording medium of claim 18, wherein controlling the user apparatus includes controlling the user apparatus of the first space based on at least one piece of state information among the stored state information of the first space and the stored state information of the second space to reproduce the space state of the second space in a same or similar way to the state of the first space.

20. The non-transitory computer readable recording medium of claim 19, wherein controlling the user apparatus includes, if a user apparatus of a same property as the second space is not present in the first space, selecting and controlling a user apparatus of a similar property to the second space to reproduce the state of the first space in a similar way to the space state of the second space.
